(19) United States
(12) Patent Application Publication
(10) Pub. No.: US 2007/0033524 A1
(43) Pub. Date: Feb. 8, 2007

(54) Mapping codes for characters in mathematical expressions

(75) Inventors: Jennifer P. Michelstein, Kirkland, WA (US); Ethan Joseph Bernstein, Seattle, WA (US); Jason Rajtar, Redmond, WA (US); Said Abou-Hallawa, Redmond, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/196,801

(22) Filed: Aug. 2, 2005

(51) Int. Cl. G06F 15/00

(52) U.S. Cl. 715/538

(57) ABSTRACT

Systems and methods for mapping character codes for characters of an mathematical expression based on changes in formatting for the characters. A system can include a document module configured for input of a mathematical expression including a plurality of characters, a format module configured to change formatting of the characters of the mathematical expression, and a mapping module configured to map a character code for one or more of the characters from a first value to a second value upon changing of the formatting of the characters. A method can include allowing entry of a mathematical expression including a plurality of characters on a computer system, allowing formatting of one or more of the characters to be changed, and mapping character codes for one or more of the characters upon changing of the formatting of the characters.

### BACKGROUND

The ability to efficiently input and save mathematical expressions in word processing applications and html editors is becoming increasingly important as more technical information is distributed in word-processed and web page formats. Each character of an expression can be identified by a unique character code defined by the Unicode Standard. For example, the character “a” in a mathematical expression can be identified as character code 1D44E of the Unicode Standard, which is used to indicate a mathematical italic small letter “a.” Properties associated with the character code for a particular character can be used to define how the character is visually represented (e.g., on a screen or as printed). Different character codes can be used to identify a particular character in a mathematical expression depending on the desired format of the character.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments described herein relate to codes used to identify characters in mathematical expressions.

One aspect relates to a system including a document module configured for input of a mathematical expression including a plurality of characters, a format module configured to change formatting of the characters of the mathematical expression, and a mapping module configured to map a character code for one or more of the characters from a first value to a second value upon changing of the formatting of the characters.

Another aspect relates to a method including: allowing entry of a mathematical expression including a plurality of characters on a computer system, allowing formatting of one or more of the characters to be changed, and mapping character codes for one or more of the characters upon changing of the formatting of the characters.

Yet another aspect relates to a computer-readable medium having computer-executable instructions for performing steps, including: allowing entry of a mathematical expression including a plurality of characters on a computer system, allowing formatting of one or more of the characters to be changed, and mapping character codes for one or more of the characters upon changing of the formatting of the characters.

### BRIEF DESCRIPTION OF THE DRAWINGS

Reference will now be made to the accompanying drawings, which are not necessarily drawn to scale, and wherein:

FIG. 1 illustrates an example general purpose computing system;

FIG. 2 illustrates a schematic of a computing system including an example application program;

FIG. 3 illustrates an example application program;

FIG. 4 illustrates the application program of FIG. 3;

FIG. 5 illustrates the application program of FIG. 3;

FIG. 6 illustrates the application program of FIG. 3;

FIG. 7 illustrates an example method for mapping character codes for characters of a mathematic expression; and

FIG. 8 illustrates another example method for mapping character codes for characters of a mathematic expression.

### DETAILED DESCRIPTION

Embodiments of the present invention will now be described more fully hereinafter with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Embodiments of the present invention relate to codes used to identify characters in mathematical expressions. Generally, the character code used to identify a character in a mathematical expression can be changed in response to changes in the formatting of the character. The character code can be used to display the character of the mathematical expression (e.g., on a screen or in a printed document).

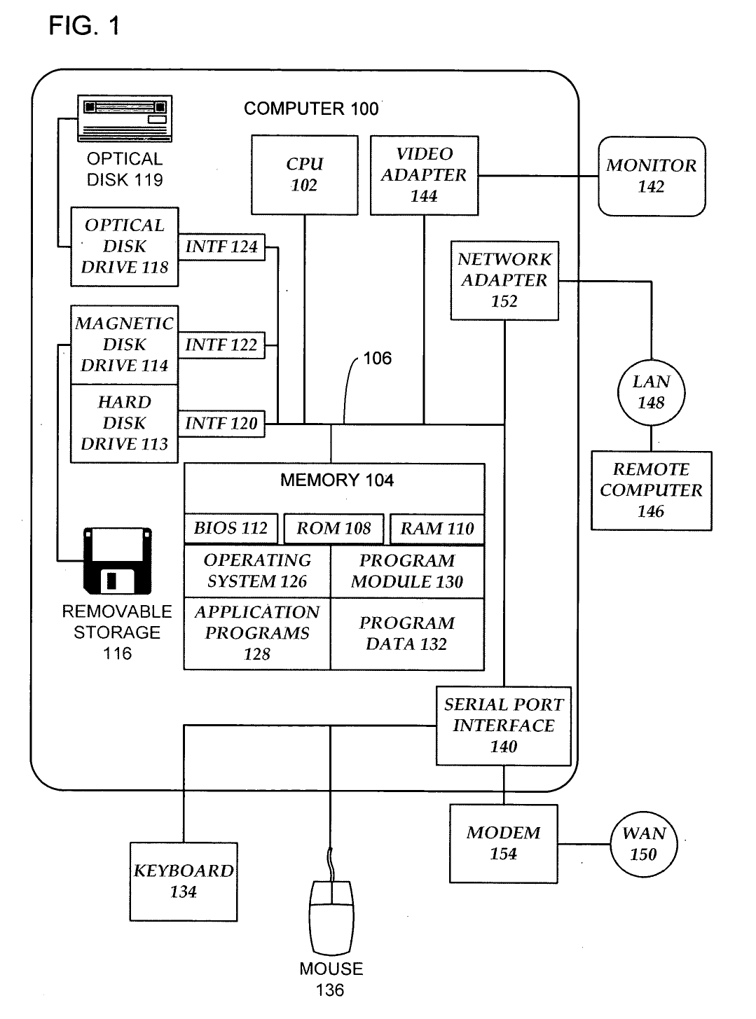

Referring now to FIG. 1, an example computer system 100 is illustrated. The computer system 100 illustrated in FIG. 1 can take a variety of forms such as, for example, a desktop computer, a laptop computer, and a hand-held computer. In addition, although computer system 100 is illustrated, the systems and methods disclosed herein can be implemented in various alternative computer systems as well.

The computer system 100 includes a processor unit 102, a system memory 104, and a system bus 106 that couples various system components including the system memory 104 to the processor unit 102. The system bus 106 can be any of several types of bus structures including a memory bus, a peripheral bus and a local bus using any of a variety of bus architectures. The system memory includes read only memory (ROM) 108 and random access memory (RAM) 110. A basic input/output system 112 (BIOS), which contains basic routines that help transfer information between elements within the computer system 100, is stored in ROM 108.

The computer system 100 further includes a hard disk drive 113 for reading from and writing to a hard disk, a magnetic disk drive 114 for reading from or writing to a removable magnetic disk 116, and an optical disk drive 118 for reading from or writing to a removable optical disk 119 such as a CD ROM, DVD, or other optical media. The hard disk drive 113, magnetic disk drive 114, and optical disk drive 118 are connected to the system bus 106 by a hard disk drive interface 120, a magnetic disk drive interface 122, and an optical drive interface 124, respectively. The drives and their associated computer-readable media provide nonvolatile storage of computer readable instructions, data structures, programs, and other data for the computer system 100.

Although the example environment described herein can employ a hard disk 113, a removable magnetic disk 116, and a removable optical disk 119, other types of computer-readable media capable of storing data can be used in the example system 100. Examples of these other types of computer-readable mediums that can be used in the example operating environment include magnetic cassettes, flash memory cards, digital video disks, Bernoulli cartridges, random access memories (RAMs), and read only memories (ROMs).

A number of program modules can be stored on the hard disk 113, magnetic disk 116, optical disk 119, ROM 108, or RAM 110, including an operating system 126, one or more application programs 128, other program modules 130, and program data 132.

A user may enter commands and information into the computer system 100 through input devices such as, for example, a keyboard 134, mouse 136, or other pointing device. Examples of other input devices include a toolbar, menu, touch screen, microphone, joystick, game pad, pen, satellite dish, and scanner. These and other input devices are often connected to the processing unit 102 through a serial port interface 140 that is coupled to the system bus 106. Nevertheless, these input devices also may be connected by other interfaces, such as a parallel port, game port, or a universal serial bus (USB). An LCD display 142 or other type of display device is also connected to the system bus 106 via an interface, such as a video adapter 144. In addition to the display 142, computer systems can typically include other peripheral output devices (not shown), such as speakers and printers.

The computer system 100 may operate in a networked environment using logical connections to one or more remote computers, such as a remote computer 146. The remote computer 146 may be a computer system, a server, a router, a network PC, a peer device or other common network node, and typically includes many or all of the elements described above relative to the computer system 100. The network connections include a local area network (LAN) 148 and a wide area network (WAN) 150. Such networking environments are commonplace in offices, enterprise-wide computer networks, intranets, and the Internet.

When used in a LAN networking environment, the computer system 100 is connected to the local network 148 through a network interface or adapter 152. When used in a WAN networking environment, the computer system 100 typically includes a modem 154 or other means for establishing communications over the wide area network 150, such as the Internet. The modem 154, which can be internal or external, is connected to the system bus 106 via the serial port interface 140. In a networked environment, program modules depicted relative to the computer system 100, or portions thereof, may be stored in the remote memory storage device. It will be appreciated that the network connections shown are examples and other means of establishing a communications link between the computers may be used.

The embodiments described herein can be implemented as logical operations in a computing system, such as the computer system 100. The logical operations can be implemented (1) as a sequence of computer implemented steps or program modules running on a computer system and (2) as interconnected logic or hardware modules running within the computing system. This implementation is a matter of choice dependent on the performance requirements of the specific computing system. Accordingly, the logical operations making up the embodiments described herein are referred to as operations, steps, or modules. It will be recognized by one of ordinary skill in the art that these operations, steps, and modules may be implemented in software, in firmware, in special purpose digital logic, and any combination thereof without deviating from the spirit and scope of the present invention as recited within the claims attached hereto. This software, firmware, or similar sequence of computer instructions may be encoded and stored upon computer readable storage medium and may also be encoded within a carrier-wave signal for transmission between computing devices.

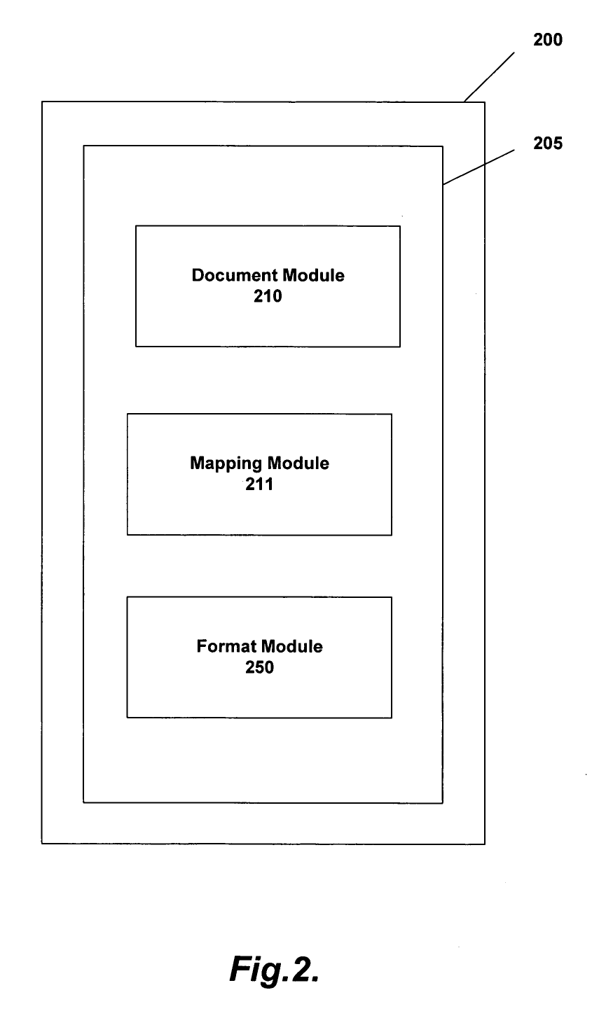

Referring now to FIG. 2, an example computer system 200 (similar to computer system 100 described above) includes an example application program 205 (similar to application programs 128 described above) running thereon. Application 205 is used to create an application document 210 including one or more mathematical expressions. In addition, application 205 includes a format module 250 that can be used, for example, to change the formatting associated with characters of the mathematical expressions in document 210, and a mapping module 211 that maps character codes associated with the characters of the mathematical expression as the formatting of the characters is changed, as described below. For example, application 205 can be a word processing application such as MICROSOFT Word from MICROSOFT Corporation of Redmond, Wash. Other types of applications programs can also be used.

As used herein, the phrase “alphanumeric character” means any character, such as a letter (e.g., A-Z, a-z, and Greek), a digit (e.g., 0-9), or a symbol (e.g., +, =, etc.), associated with a mathematical expression. The phrase “alphabetic character” means any letter (e.g., A-Z, a-z, and Greek). The phrase “numeric character” means any digit (e.g., 0-9). The phrase “plane 0” refers to a range of character codes of 0000-007F typically associated with alphanumeric characters of a mathematical expression having a non-italic and non-bold format, as defined by the Unicode Standard described below (sometimes referred to as “plain” or “basic multilingual plane”). The phrase “plane 1” refers to an extended range of characters codes (referred to as plane 1 because of the hexadecimal values this range falls within) of “1D400-1D7FF” typically associated with alphanumeric characters of a mathematical expression having a specific format (e.g., mathematical italic or mathematical bold), as defined by the Unicode Standard described below.

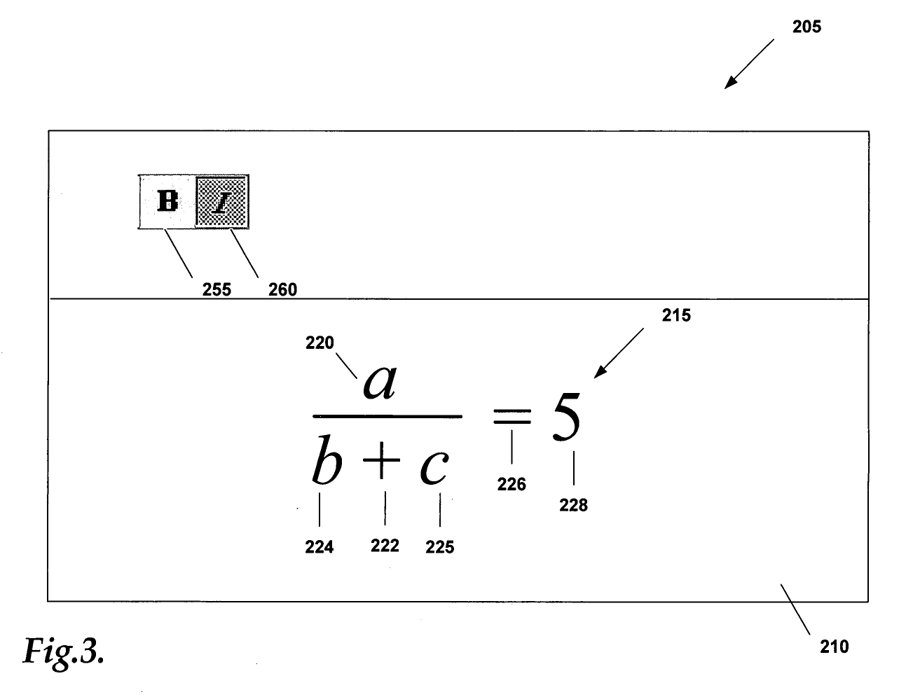

Referring now to FIG. 3, document 210 includes an example mathematical expression

$$215 {(}^{``} \frac{a}{b + c} = {5}^{″} ) .$$

Note that the characters of the mathematical expressions shown herein are displayed with italic formatting rather than with mathematical italics due to limitations of the word processing equipment. The characters in the mathematical expressions herein with italic formatting are used to represent characters with mathematical italics as typically used in mathematical expressions.

In one example, a user inputs the mathematical expression 215 in document 210 using application 205. The user can input the mathematical expression 215 using a format such as the linear format disclosed in U.S. patent application Ser. No. 10/943,095, filed on Sep. 15, 2004 and entitled “Systems and Methods for Automated Equation Buildup.” For example, the linear format for expression 215 is a/(b+c)=5. The mathematic expression 215 can be automatically built-up as the expression 215 is entered so that the expression is shown in a two-dimensional format to the user.

The mathematical expression 215 can be saved in document 210 in accordance with the example extensible markup language notation for mathematical expressions disclosed in U.S. patent application Ser. No. 11/067,540, filed on Feb. 22, 2005 and entitled “Extensible Markup Language Schema for Mathematical Expressions.” Other methods for entering and saving mathematical expression 215 can also be used.

As mathematical expression 215 is entered, each character is formatted according to an appropriate mathematical notation. For example, alphabetic characters in a mathematical expression are generally displayed using mathematical italics. Non-alphabetic characters (e.g., numbers and mathematical symbols) are generally displayed without mathematical italics.

Each character of expression 215 is identified by a unique character code. In the example shown, the Unicode Standard is used to identify each character. See, for example, The Unicode Consortium; The Unicode Standard, Version 4.1.0, defined by: The Unicode Standard, Version 4.0 (Boston, Mass., Addison-Wesley, 2003; ISBN 0-321-18578-1), as amended by Unicode 4.0.1 (www.unicode.org/versions/Unicode4.0.1) and by Unicode 4.1.0 (www.unicode.org/versions/Unicode4.1.0). The Unicode Standard includes character codes for characters used in mathematical expressions.

The Unicode Standard includes ranges for character codes for plane (i.e., non-mathematical italic and non-bold) characters. These character codes fall within what will be referred to herein as the “plane 0” range of the Unicode Standard. The Unicode Standard also includes ranges for mathematical italic characters and mathematical bold characters. These character codes typically fall within the Unicode Standard range referred to as the “plane 1” range.

For example, as character 220 (“a”) is entered by the user into document 210, character 220 is identified as an alphabetic character that is displayed in mathematical italics. Character 220 is therefore identified with the Unicode character code “1D44E” for the small math italic “a” character. Characters 224 (“b”) and 225(“c”) are likewise identified as alphabetic characters that are identified as character codes “1D44F” and “1D450” used for the small mathematical italics “b” and “c” characters. The codes for math italic “a,” “b,” and “c” are referred to as “plane 1” codes. As characters 222 and 226 (“+” and “=”) are entered, characters 222 and 226 are identified as mathematical operators and are therefore identified using character codes “002B” and “003D,” respectively. Finally, as character 228 (“5”) is entered, character 228 is identified as a numeric character identified as character code “0035” used for the plain (i.e., non-italic) digit five in the plane 0 range.

In the illustrated embodiment, each character of the mathematical expression 215 can be stored in file 210 according to the character's plane 0 value. Attributes such as formatting (e.g., italics/bold) can be associated with the each characters stored in file 210. In other words, characters with character codes in the plane 1 range can be converted to the plane 0 range and formatting attributes (e.g., italics/bold) can be associated with the characters when saved in file 210. In this manner, characters in file 210 can be used by other application programs that are not configured to handle plane 1 character codes. When application program 205 accesses file 210 and expression 215 therein, application program 205 can remap the appropriate character codes of mathematical expression 215 from plane 0 to plane 1. For example, the alphabetic character “a” in mathematical expression 215 can be mapped to the plane 0 value “0061” for storage in file 210. In addition, the italic formatting associated with the alphabetic character “a” can be stored as an attribute of the character. When application program 205 accesses the alphabetic character “a” from file 210, application program 205 can, based on the plane 0 value “0061” and italic formatting associated with the character, remap the character code for “a” from the plane 0 value “0061” to the plane 1 value “1D44E.”

For example, characters 220, 222, 224, 225, 226, and 228 can be formatted for display according to the character codes used to identify the characters. In the example shown, characters 220, 224, and 225 can be identified and displayed as mathematical italics based on the plane 1 character codes “1D44E,” “1D44F,” and “1D450” used to identify characters 220, 224, and 225. Other formatting associated with the characters, such as spacing surrounding the characters, can also be generated based on the character codes used to identify each character in the mathematical expression. See, for example, U.S. patent application Ser. No. 11/129,149, filed on May 13 2005 and entitled “Method and System of Character Placement in Opentype Fonts.”

Application program 205 also includes buttons 255 and 260 that allow the user to modify the appearance of characters 220, 222, 224, 225, 226, and 228 in mathematical expression 215. In the example shown, button 255 is associated with bold formatting, and button 260 is associated with italic formatting. The user can select either or both of buttons 255 and 260 (e.g., by clicking a button using an input device such as a mouse) to change the appearance of the characters in mathematical expression 215 of document 210. For example, the user can select button 260 to toggle the appearance of italic formatting to the selected character(s) of a given mathematical expression.

The state of buttons 255 and 260 can be changed as formatting of characters is toggled to indicate the current state of the selected character(s). For example, as shown in FIG. 3, as mathematical expression 215 is entered, button 260 is shown as being active (i.e., selected) to show that the alphabetic characters are associated with mathematical italics.

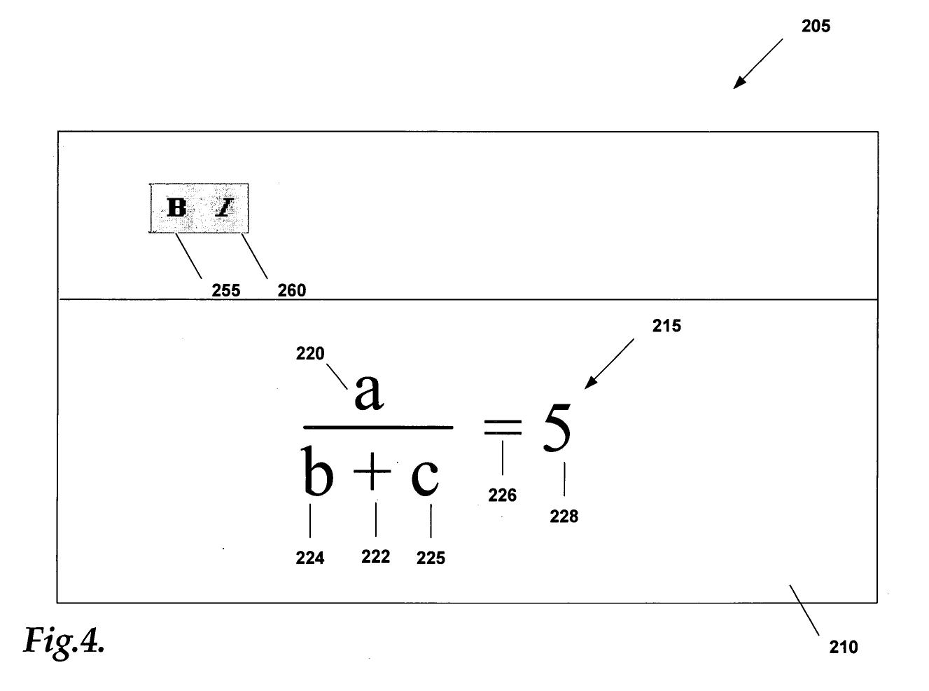

Referring now to FIG. 4, the user can select mathematical expression 215 using an input device such as a mouse or keyboard. The user can then select button 260 to toggle the application of italic formatting to mathematical expression 215. Since alphabetic characters 220, 224, and 225 are already displayed in mathematical italic format, characters 220, 224, and 225 are changed from italic to plain when the user selects button 260. Characters 220, 224, and 225 are therefore mapped from their Unicode Standard plane 1 character codes of “1D44E,” “1D44F,” and “1D450” to their plane 0 equivalents “0061,” “0062,” and “0063.”

In the example shown, non-alphabetic characters that have no mathematical italic equivalents are displayed without italic formatting. Therefore, when button 260 is selected, characters 222, 226, and 228 remain as plain characters with character codes “002B,” “003D,” and “0035,” respectively. In one example, a state of button 260 is toggled so that when one or more of characters 222, 226, and 228 are selected, the state of button 260 is changed so that it is shown as selected or unselected even though characters 222, 226, and 228 are not displayed with italic formatting.

If, after selecting expression 215 and button 260 to toggle italics, the user again selects expression 215 and button 260 to toggle italic formatting a second time, characters 220, 224, and 225 are again displayed with mathematical italics and are mapped back from plane 0 Unicode Standard character codes “0061,” “0062,” and “0063” to their plane 1 character codes “1D44E,” “1D44F,” and “1D450.” Characters 222, 226, and 228 remain as plain characters with character codes “002B,” “003D,” and “0035,” respectively. The state of button 260 is also toggled back to that shown in FIG. 3.

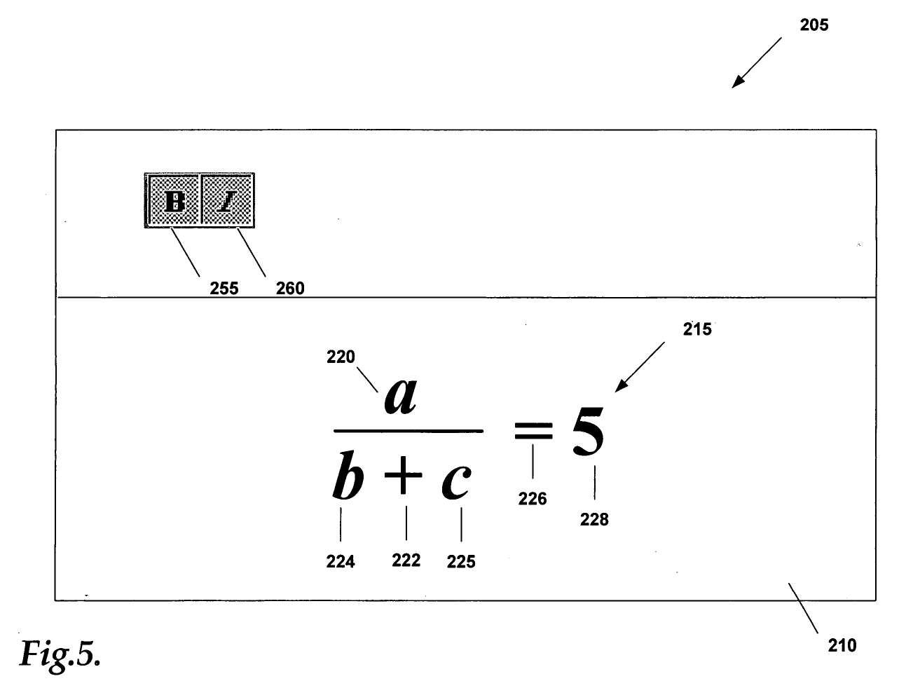

Referring now to FIG. 5, if the user instead selects expression 215 shown in FIG. 3 and selects button 255 to toggle the application of bold formatting, the character code for alphabetic character 220 is mapped from plane 1 value “1D44E” to plane 1 value “1D482” used to identify a mathematical bold italic small “a.” Likewise, the character codes for alphabetic characters 224 and 225 are mapped from plane 1 values “1D44F” and “1D450” to plane 1 values “1D483” and “1D484” used to identify mathematical bold italic small “b” and “c.” In a similar manner, the character code for numeric character 228 is mapped from the plane 0 value “0035” to a plane 1 value “1D7D3” used to identify a mathematical bold digit five. No plane 1 value currently exists for the mathematical symbols associated with characters 222 and 226. Therefore, the character codes for characters 222 and 226 remain “002B” and “003D,” respectively. However, in the example shown, application program 205 can be programmed to change attributes associated with characters 222 and 226 to display characters 222 and 226 in a bold format. The state of button 255 is also changed appropriately as shown.

If the user decides to toggle bold formatting by again selecting button 255 when mathematical expression 215 is in the state shown in FIG. 5, the character codes for characters 220, 224, and 225 are mapped back to plane 1 values “1D44E,” “1D44F,” and “1D450,” and the character code for character 228 is mapped back to the plain (i.e., non-bold) value “0035” in the plane 0 range. In addition, attributes associated with characters 222 and 226 are changed to display characters 222 and 226 in a plain (i.e., non-bold) format.

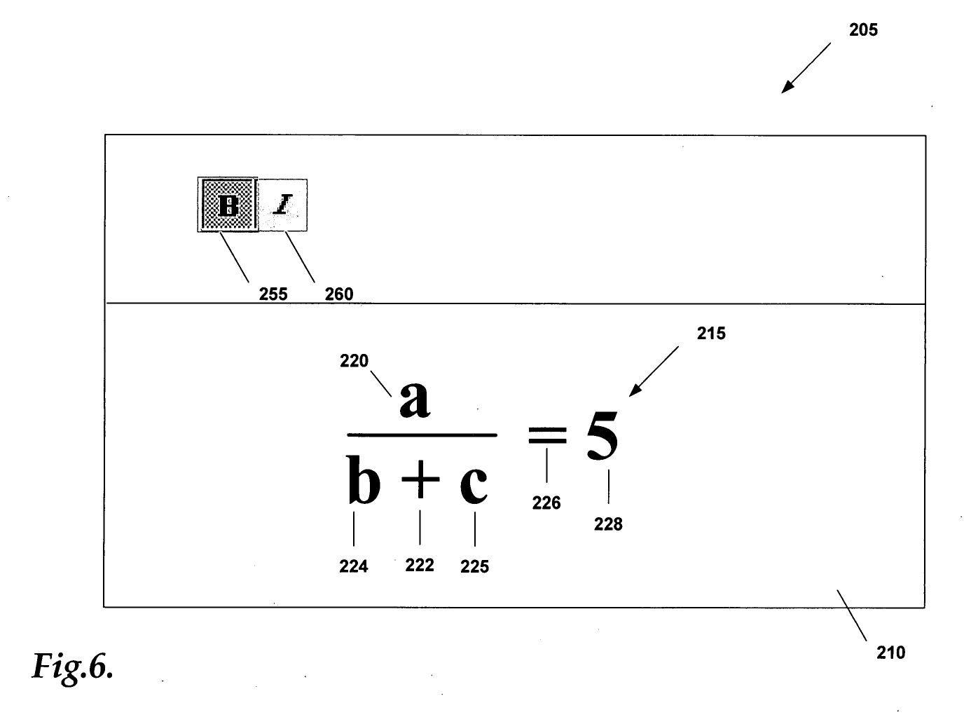

Referring now to FIG. 6, if the user instead selects expression 215 shown in FIG. 3 and selects both buttons 255 and 260 to toggle the application of bold and italic formatting, alphabetic character 220 is mapped from plane 1 value “1D44E” to plane 1 value “1D41A” used to identify a mathematical bold small “a.” Likewise, the character codes for alphabetic characters 224 and 225 are mapped from plane 1 values “1D44F” and “1; D450” to plane 1 values “1D41B” and “1D41C” used to identify mathematical bold small “b” and “c.” In a similar manner, the character code for numeric character 228 is mapped from the plane 0 value “0035” to a plane 1 value “1D7D3” used to identify a mathematical bold digit five. Further, attributes associated with characters 222 and 226 are changed to display characters 222 and 226 in a bold format. As noted above, non-alphabetic characters 222, 226, and 228 (e.g., numerals and mathematic symbols) are not displayed with italic formatting.

If the user decides to toggle both bold and italic formatting by again selecting buttons 255 and 260 when mathematical expression 215 is in the state shown in FIG. 6, the character codes for characters 220, 224, and 225 are mapped back to plane 1 values “1D44E”, “1D44F,” and “1D450,” and the character code for character 228 is mapped back to the plane 0 (i.e., non-bold) value “0035.” In addition, attributes associated with characters 222 and 226 are changed to display characters 222 and 226 in a plain (i.e., non-bold) format.

Although the examples shown in FIGS. 4-6 illustrate changes in formatting that occur when the entire expression 215 is selected, a user can select and change the formatting of only a portion of an expression or a single character as well. The toggling of formatting is handled in a manner similar to that shown in FIGS. 4-6, except that the changes in formatting are only applied to the selected portion of the expression or selected single character.

In the example shown, if the user selects a portion of a mathematical expression including characters of different formats (e.g., both an italic and non-italic character), formatting is toggled to an opposite of that of the state of the first character in the selected portion. For example, if the first character of the selected portion is italic and the italic button is selected, formatting for the entire selected portion is toggled from italic to non-italic.

In the illustrated embodiment, the user can change the state of the bold and/or italic buttons 255, 260 prior to typing a character as well. For example, alphabetic characters of the mathematical expression in the illustrated embodiment are displayed in mathematical italics by default. If the user clicks button 260 to unselect mathematical italics and then types an alphabetic character for the mathematical expression, that character is displayed in plain (i.e., non-mathematical italic) format and stored using a plane 0 character code.

In another embodiment, characters that are pasted into a mathematical expression are automatically converted to the current formatting state. For example, if the current formatting state is the default state (i.e., mathematical italics for alphabetic characters), and a plain alphabetic character is pasted into the mathematical expression, the character code for the pasted alphabetic character is automatically mapped to the plane 1 range. Similarly, a user can select plain text and convert the text to a mathematical expression. During this conversion, characters are mapped to their appropriate character codes. For example, if an alphabetic character is included in the selected plain text, the character code for the alphabetic character is mapped to the plane 1 value.

In one example, application program 205 can be programmed to both store the appropriate character code for a character of the mathematical expression, and store format attributes (e.g., italics/bold) associated with the character. For example, when an alphabetic character is added to a mathematical expression, application program 205 selects the plane 1 character code for the alphabetic character. In the illustrated embodiment, application program 205 also sets a format attribute with the character that indicates that the character is associated with italic formatting. When the application program 205 displays the character, the application program 205 can format the character in accordance with the formatting associated with the plane 1 character code.

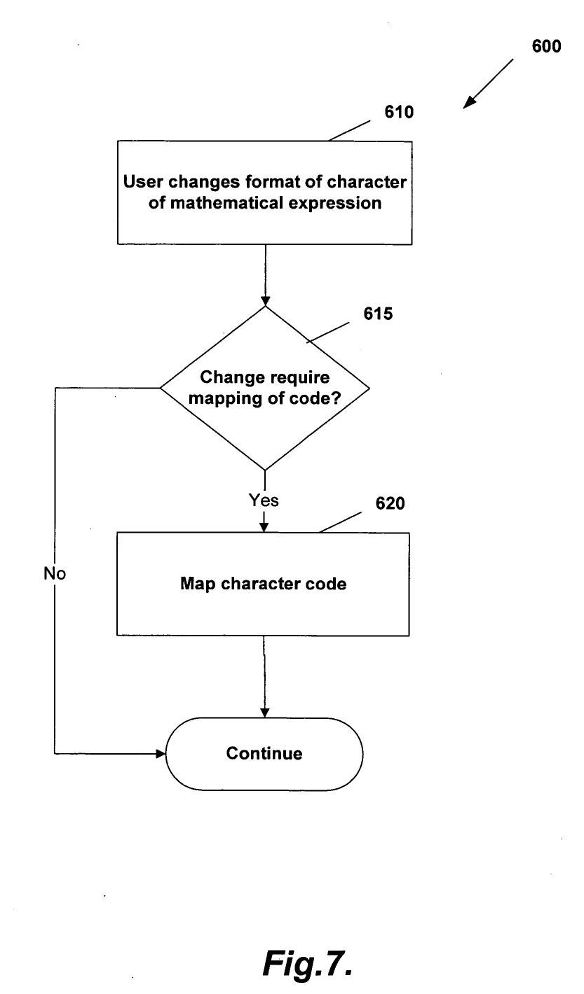

Referring now to FIG. 7, an example method 600 for changing the formatting of a character of a mathematical expression is shown. At operation 610, the user changes the formatting of a character of a mathematical expression. For example, the user can select and toggle the formatting associated with a character such as character 220 of expression 215 shown in FIG. 3. Next, in operation 615, a determination is made regarding whether the change in formatting requires a mapping of the character code associated with the character. If mapping is required, control is passed to operation 620 and the character code associated with the character is mapped to a new value. For example, if character 220 (“a”) is selected and the italic button 260 is then selected, the character code for character 220 is mapped from plane 1 to plane 0 (e.g., from character code “1D44E” to character code “0061”).

If a determination at operation 615 is made that no mapping is required, no character mapping is performed. For example, if character 228 (“5”) is selected and the italic button 260 is then selected, the character code for character 228 remains the same because numeric characters are not displayed in mathematical italics.

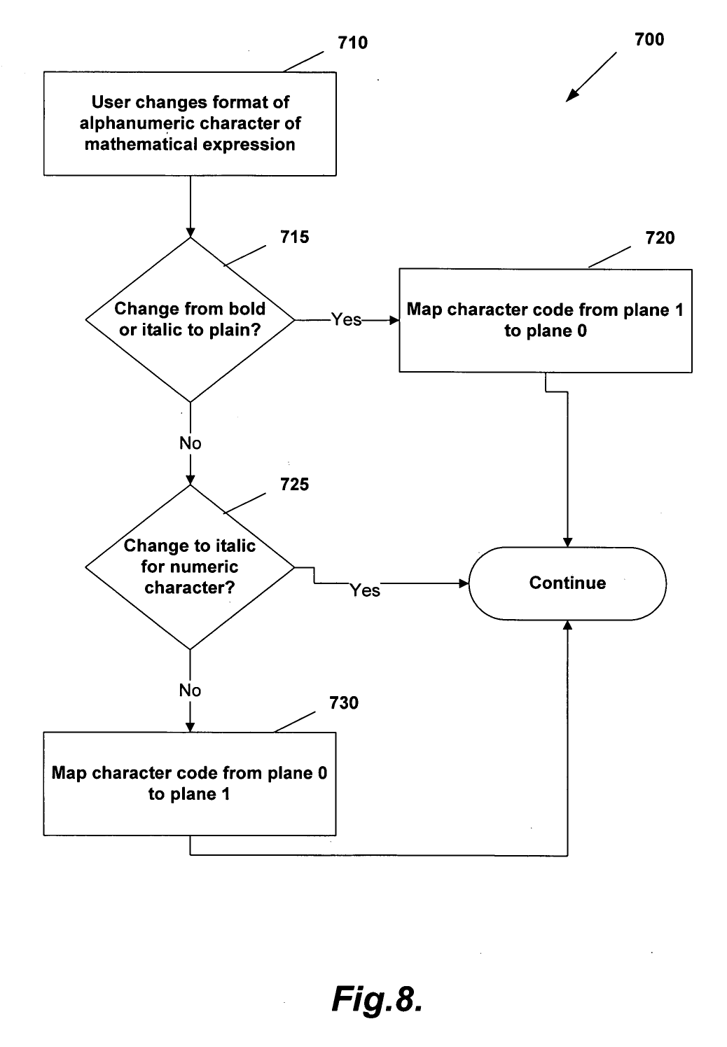

Referring now to FIG. 8, an example method 700 is shown for mapping a character code when changes are made to formatting for an alphanumeric character (e.g., characters 220, 224, 228). At operation 710, the user changes the format of an alphanumeric character of a mathematical expression. Next, at operation 715, a determination is made regarding whether the format change is from bold or italic to plain. If the change is from bold or italic to plain, control is passed to operation 720, and the character code associated with the character is mapped from a plane 1 value to a plane 0 value.

If a determination is made at operation 715 that the change in formatting is not from bold or italic to plain, control is passed to operation 725. At operation 725, a determination is made regarding whether the change in formatting is a change in italic formatting for a numeric character. If it is determined that the change is for italic formatting of a numeric character, no mapping occurs because numeric characters are not displayed in italic. If a determination is made at operation 725 that the change is not for italic formatting of a numeric character (i.e., is instead for changing the format of a numeric character to bold, or for changing the format of an alphabetic character to bold or italic), control is passed to operation 730, and the character code associated with the character is mapped from a plane 0 value to a plane 1 value.

In this manner, the character code for a character can be mapped in response to changes to formatting associated with the character so that the character code reflects the current formatting of the character. Mapping of the character code can be done without affirmative action by the user, so that the user does not have to understand the mapping when the user makes a change to the format of a character of a mathematical expression.

Although the examples provided herein have been described with respect to certain types of formatting (e.g., bold and italic), other types of formatting can be handled in a similar manner. In addition, although certain characters have been used in the examples, other characters (e.g., alphanumeric and mathematical symbols) can be handled in a similar manner. Further, although example ranges of the Unicode Standard are provided, other ranges of the standard can be used as well. Although the examples shown include buttons to change formatting in the mathematical expressions, a user can utilize other methods to make changes in formatting as well, such as keyboard shortcuts (e.g., control-i to change italic formatting, and control-b to change bold formatting).

The various embodiments described above are provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention, which is set forth in the following claims.

The claimed invention is:

1. An application for a computing system, comprising:
a document module configured for input of a mathematical expression including a plurality of characters;
a format module configured to change formatting of the characters of the mathematical expression; and
a mapping module configured to map a character code for one or more of the characters from a first value to a second value upon changing of the formatting of the characters.

2. The application of claim 1, wherein the mapping module is configured to map the character code for the character from the first value to the second value upon changing of the character from italic formatting to non-italic formatting.

3. The application of claim 2, wherein the character is an alphabetic character.

4. The application of claim 2, wherein the character code is mapped from a plane 1 value to a plane 0 value.

5. The application of claim 2, wherein the character code is converted from a plane 1 value to a plane 0 value when the document module is stored to a storage medium.

6. The application of claim 1, wherein the mapping module is configured to map the character code for the character from the first value to the second value upon changing of the character from non-bold formatting to bold formatting.

7. The application of claim 6, wherein the character code is mapped from a first plane 1 value to a second plane 1 value.

8. The application of claim 1, wherein the format module updates a state of a button of the format module upon the changing of formatting of the characters.

9. A method, comprising:
allowing entry of a mathematical expression including a plurality of characters on a computer system;
allowing formatting of one or more of the characters to be changed; and
mapping character codes for one or more of the characters upon changing of the formatting of the characters.

10. The method of claim 9, further comprising:
changing formatting of an alphabetic character from italic formatting to non-italic formatting; and
mapping a character code for the alphabetic character from a first value to a second value.

11. The method of claim 9, further comprising:
converting the character codes for the characters; and
storing the mathematical expression on a storage medium.

12. The method of claim 9, further comprising:
changing formatting of an alphabetic character from non-bold formatting to bold formatting; and
mapping a character code for the alphabetic character from a first plane 1 value to a second plane 1 value.

13. The method of claim 9, further comprising:
changing formatting of a non-alphabetic character from non-italic formatting to italic formatting; and
updating a state of a format module to reflect the change in the formatting of the non-alphabetic character from non-italic formatting to italic formatting; and
leaving a character code for the non-alphabetic character unchanged.

14. The method of claim 9, further comprising:
changing formatting of a non-alphabetic character from non-bold formatting to bold formatting; and
mapping a character code for the non-alphabetic character from a first value to a second value.

15. The method of claim 9, further comprising updating a state of a format module to reflect the change in the formatting of the characters.

16. A computer-readable medium having computer-executable instructions for performing steps comprising:
allowing entry of a mathematical expression including a plurality of characters on a computer system;
allowing formatting of one or more of the characters to be changed; and
mapping character codes for one or more of the characters upon changing of the formatting of the characters.

17. The computer-readable medium of claim 16, further comprising:
changing formatting of an alphabetic character from italic formatting to non-italic formatting; and
mapping a character code for the alphabetic character from a first value to a second value.

18. The computer-readable medium of claim 17, further comprising:
changing the formatting of the alphabetic character from non-italic formatting to italic formatting; and
mapping the character code for the alphabetic character from the second value to the first value.

19. The computer-readable medium of claim 16, further comprising:
changing formatting of an alphabetic character from non-bold formatting to bold formatting; and
mapping a character code for the alphabetic character from a first plane 1 value to a second plane 1 value.

20. The computer-readable medium of claim 16, further comprising:
changing formatting of a non-alphabetic character from non-italic formatting to italic formatting; and
updating a state of a format module to reflect the change in the formatting of the non-alphabetic character from non-italic formatting to italic formatting; and
leaving a character code for the non-alphabetic character unchanged.
